(19) United States
(12) Patent Application Publication
(10) Pub. No.: US 2011/0241951 A1
(43) Pub. Date: Oct. 6, 2011

(54) PORTABLE WIRELESS APPARATUS

(75) Inventors: Akito Sakamoto, Kanagawa (JP); Hideki Hayama, Tokyo (JP); Takeshi Yamaguchi, Kanagawa (JP)

(73) Assignee: PANASONIC CORPORATION, Osaka (JP)

(21) Appl. No.: 13/131,935

(22) PCT Filed: Jun. 22, 2009
(86) PCT No.: PCT/JP2009/002826

§ 371 Date: May 31, 2011

(30) Foreign Application Priority Data
Dec. 12, 2008 (JP) 2008-317387

(51) Int. Cl. H01Q 1/24

(52) U.S. Cl. 343/702

(57) ABSTRACT

Disclosed is a portable wireless apparatus that can be miniaturised and reduced in thickness without increasing in manufacturing costs and that can prevent degradation of reception sensitivity when placed on a metal plate, without impairing design characteristics. In this apparatus, a conductive hinge (103) links a first case (101) and second case (102) in a mutually movable fashion. A first antenna element (108) has a base end (150) that is supplied with power from a power supply section (106) and provided in a position facing the hinge (103), and is arranged on the second case (102) in such a way that the distance r1 from the bottom face (160) of the second case (102) on the side of the tip (151) extending from the base end (150) is larger than the distance r2 from the bottom face (160) of the second case (102) on the side of the base end (150).

### TECHNICAL FIELD

The present invention relates to a portable radio device, and more particularly to a portable radio device capable of maintaining high reception sensitivity while the portable radio device is placed on a metal plate such as a steel desk.

### BACKGROUND ART

In general, a user does not necessarily carry a portable radio device such as a cell phone with him/her, and he/she often waits for incoming calls while the portable radio device is placed on a metal desk such as a steel desk. In this case, the antenna of the portable radio device is in proximity to the metal disk each other, and is coupled with the metal desk, whereby a current having a phase opposite to the antenna current flows on the metal surface of the metal desk. As a result, in the past, the directional pattern of the radiation of the antenna is changed, and the characteristics of the VSWR (Voltage Standing Wave Ratio) are greatly changed. There is a problem in that this reduces the matching state of the antenna and reduces the radiation gain.

Conventionally, one of methods for solving this problem is as follows. A portable radio device is known to have a rib on the back surface of the portable radio device so as to increase the distance between the antenna of the portable radio device and the metal desk, thus achieving high reception sensitivity (for example, patent literature 1).

Alternatively, a portable radio device is known to have such a configuration in which a radiation element and an auxiliary ground plate provided in the portable radio device are electrically connected to a circuit substrate of the portable radio device so that an electric field is emitted in a direction perpendicular to a desk when the portable radio device is placed on the metal desk, thus improving the reception sensitivity (for example, patent literature 2).

### Citation List

### Patent Literature

### PTL 1

Japanese Patent Application Laid-Open No. H10-126304

### PTL 2

### Japanese Patent Application Laid-Open No. 2007-329962

### SUMMARY OF THE INVENTION

### Technical Problem

In the patent literature 1, however, the thickness of the casing increases due to the rib, which makes it difficult to reduce the thickness of the casing, and moreover there is a problem in that the rib protrudes from the casing, and this reduces the quality of the design. In the patent literature 2, it is necessary to additionally arrange the radiation element and the auxiliary ground plate. As a result, the number of component parts increases, which increases the manufacturing cost, and moreover, the casing needs to have a space for the radiation element and the auxiliary ground plate. Therefore, there is a problem in that it is difficult to reduce the size and reduce the thickness.

An object of the present invention is to provide a portable radio device which is small and thin but the manufacturing cost is still low, and while the quality of the design is not deteriorated, the reduction of the reception sensitivity is prevented even when the portable radio device is placed on a metal plate.

### Solution to Problem

A portable radio device according to the present invention includes a first casing, a second casing, a conductive coupling member that couples the first casing and the second casing in a mutually movable fashion, and a first antenna element that is fed by a feeding section and has a base end section arranged at a position to face the coupling member in a vertical direction, wherein the first antenna element is arranged in the second casing such that the distance between a front end section side extending from the base end section and a bottom surface of the second casing is greater than the distance from the bottom surface of the base end section side.

### Advantage Effects of Invention

According to the present invention, a portable radio device is provided which is small and thin but the manufacturing cost is still low, and while the quality of the design is not deteriorated, the reduction of the reception sensitivity is prevented even when the portable radio device is placed on a metal plate.

### BRIEF DESCRIPTION OF DRAWINGS

FIG. 1 is a plan view illustrating a second casing of a portable radio device according to Embodiment 1 of the present invention;

FIG. 2 is a front view illustrating the portable radio device according to Embodiment 1 of the present invention; FIG. 3 is a cross sectional view taken along line C-C′ in FIG. 1;

FIG. 4 is a cross sectional view taken along line B-B′ in FIG. 1;

FIG. 5 is a cross sectional view taken along line A-A′ in FIG. 1;

FIG. 6 is a figure illustrating VSWR characteristic according to Embodiment 1 of the present invention;

FIG. 7 is a front view of a portable radio device illustrating another example of a first antenna element according to Embodiment 1 of the present invention;

FIG. 8 is a front view of a portable radio device illustrating still another example of a first antenna element according to Embodiment 1 of the present invention;

FIG. 9 is a front view of a portable radio device illustrating still another example of a first antenna element according to Embodiment 1 of the present invention;

FIG. 10 is a plan view illustrating a second casing of a portable radio device according to Embodiment 2 of the present invention;

FIG. 11 is a cross sectional view taken along line E-E′ in FIG. 10; and

FIG. 12 is a cross sectional view taken along line E-E′ in FIG. 10 illustrating another example of a second antenna element according to Embodiment 2 of the present invention.

### DESCRIPTION OF EMBODIMENTS

Embodiments of the present invention will be hereinafter explained in detail with reference to the accompanying drawings.

### Embodiment 1

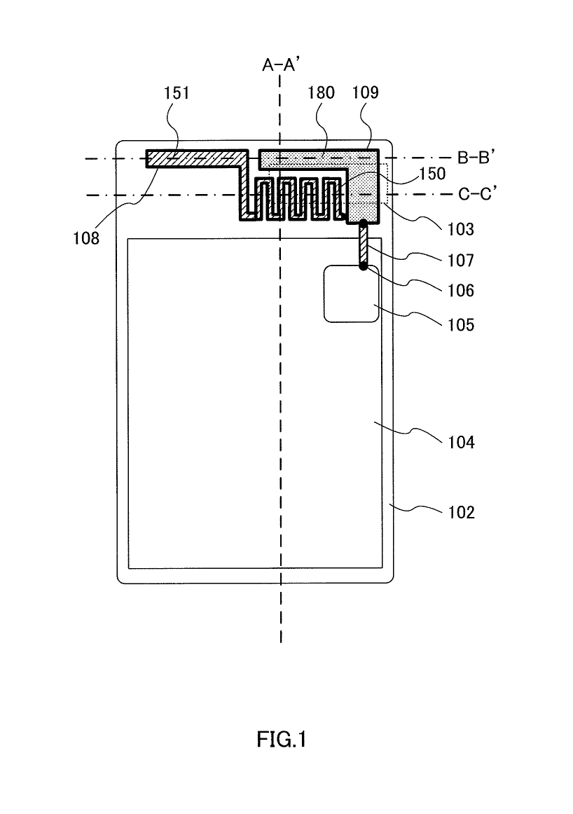

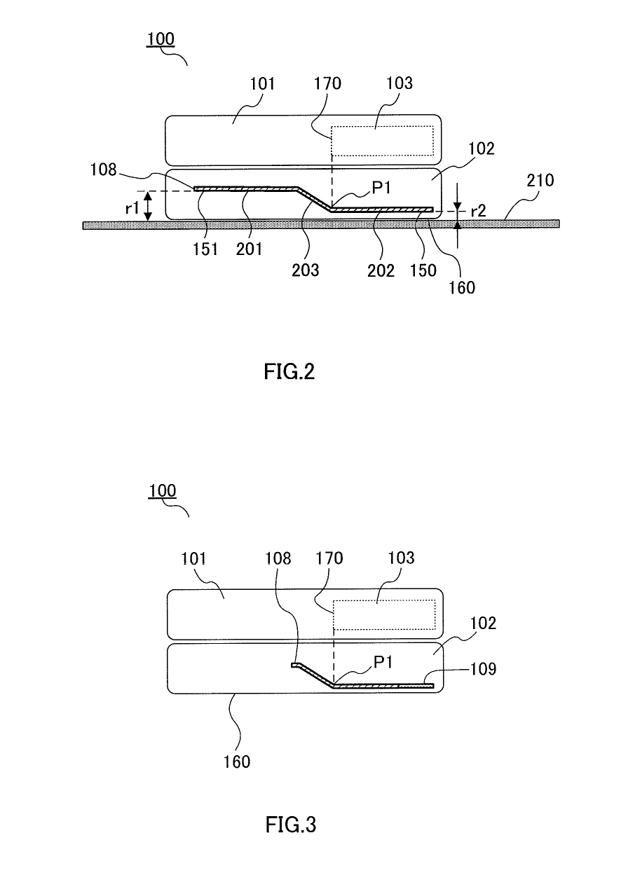

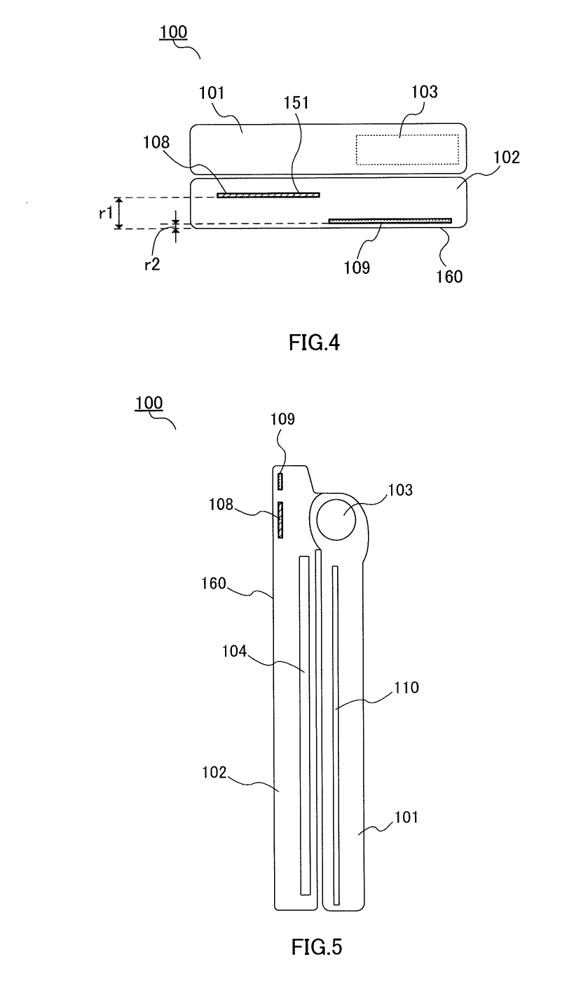

FIG. 1 is a plan view illustrating second casing 102 of portable radio device 100 according to the present embodiment. FIG. 2 is a front view illustrating portable radio device 100 according to the present embodiment. FIG. 3 is a cross sectional view taken along line C-C′ in FIG. 1. FIG. 4 is a cross sectional view taken along line B-B′ in FIG. 1. FIG. 5 is a cross sectional view taken along line A-A′ in FIG. 1. For the sake of explanation, circuit substrate 104, matching circuit 105, feeding section 106, feeding element 107, and second antenna element 109 are omitted in FIG. 2. Circuit substrate 104, matching circuit 105, feeding section 106, and feeding element 107 are omitted in FIGS. 3 and 4. Matching circuit 105, feeding section 106, and feeding element 107 are omitted in FIG. 5.

Portable radio device 100 mainly includes first casing 101, second casing 102, hinge section 103, circuit substrate 104, matching circuit 105, feeding section 106, feeding element 107, first antenna element 108, second antenna element 109, and circuit substrate 110.

Each component will be explained in detail with reference to FIGS. 1 to 5.

First casing 101 has a rectangular shape on a plan view, and as shown in FIG. 5, first casing 101 includes hinge section 103 and circuit substrate 110. First casing 101 is rotatably coupled with second casing 102 via hinge section 103. When first casing 101 is closed, first casing 101 overlaps second casing 102 as shown in FIGS. 2 to 4 when first casing 101 and second casing 102 are seen on a plan view. Further, first casing 101 has a sub-display section such as a liquid crystal display section (LCD), not shown, that is exposed to the outside when first casing 101 is closed. When a call is received, the sub-display section provided on first casing 101 has a function of, e.g., displaying a caller registered in advance in portable radio device 100. Therefore, when a user waits for a call, the user usually places portable radio device 100 on a desk and the like such that first casing 101 is at the upper side.

Second casing 102 has a rectangular shape on a plan view, and second casing 102 is rotatably coupled with first casing 101 via hinge section 103. As shown in FIG. 1, second casing 102 includes circuit substrate 104, matching circuit 105, feeding section 106, feeding element 107, first antenna element 108, and second antenna element 109. Further, second casing 102 includes an operation panel not shown.

Hinge section 103 is made of a conductive metal material, and is provided on first casing 101, so that hinge section 103 rotatably couples first casing 101 with second casing 102. Hinge section 103 needs to have a certain level of rigidity so that hinge section 103 is not damaged when first casing 101 and second casing 102 are repeatedly pivoted. Therefore, hinge section 103 is usually made of metal material.

As shown in FIG. 1, circuit substrate 104 is provided on second casing 102, and includes matching circuit 105, feeding section 106, and feeding element 107.

Matching circuit 105 is electrically connected to feeding section 106.

Feeding section 106 is electrically connected to matching circuit 105, and feeding section 106 feeds power to first antenna element 108 and second antenna element 109 via feeding element 107.

Feeding element 107 electrically connects feeding section 106 with second antenna element 109.

For example, first antenna element 108 is formed with a flexible substrate (FPC) or a metal plate, and is integrally formed with second antenna element 109. Further, first antenna element 108 is fed from feeding section 106 via feeding element 107 and second antenna element 109, and first antenna element 108 has base end section 150 provided at a position to face hinge section 103 in upward and downward directions (see FIGS. 1 and 2). Further, first antenna element 108 is provided in second casing 102 so that the distance between bottom surface 160 of second casing 102 and front end section side 201 extended from base end section 150 is greater than the distance between bottom surface 160 of second casing 102 and base end section side 202 (see FIG. 2). For example, first antenna element 108 oscillates in 800 MHz band. It should be noted that first antenna element 108 will be explained later in detail.

Second antenna element 109 is in a substantially inverted-L shape on a plan view, and, for example, second antenna element 109 is made of a flexible substrate (FPC) or a metal plate, and is integrally formed with first antenna element 108. Further, second antenna element 109 oscillates at a higher frequency than the resonance frequency of first antenna element 108, and therefore, second antenna element 109 is formed so that the antenna length of second antenna element 109 is shorter than that of first antenna element 108. For example, second antenna element 109 oscillates in 2 GHz band.

Circuit substrate 110 as shown in FIG. 5 is provided in first casing 101.

Subsequently, first antenna element 108 will be explained further in detail with reference to FIGS. 1 to 5.

As shown in FIG. 2, on a plan view, first antenna element 108 includes base end section side 202 arranged parallel to bottom surface 160 of second casing 102, front end section side 201 arranged parallel to bottom surface 160 of second casing 102 and whose distance from bottom surface 160 of second casing 102 is different from the distance of base end section side 202 therefrom, and inclined section 203 provided between base end section 150 and front end section 151 and inclining upward.

More specifically, inclined section 203 is formed by bending front end section 151 side upward in position P1 to face edge section 170 of hinge section 103 between base end section 150 and front end section 151 (see FIGS. 2 and 3). Further, front end section side 201 is formed by bending an end section of inclined section 203 at the side of front end section 151 so that front end section side 201 is arranged parallel to bottom surface 160 of second casing 102 (see FIG. 2).

Accordingly, first antenna element 108 is provided in second casing 102 so that distance r1 between front end section side 201 and bottom surface 160 of second casing 102 is greater than distance r2 between base end section side 202 and bottom surface 160 of second casing 102 (r1>r2). Further, first antenna element 108 is in a meandering form from base end section 150 to a substantially intermediate section (see FIG. 1).

Further, first antenna element 108 is provided in second casing 102 so that, on a plan view, the longitudinal direction of front end section 151 is arranged parallel to the longitudinal direction of long side section 180 of second antenna element 109 (horizontal direction of FIG. 1) (see FIG. 1). On a plan view, first antenna element 108 is arranged so that base end section side 202 overlaps hinge section 103 in a vertical direction. Since base end section 150 is electrically connected to second antenna element 109, first antenna element 108 is fed by feeding section 106 via feeding element 107 and second antenna element 109.

Alternatively, in first antenna element 108, the lower surface of inclined section 203 or front end section side 201 bent upward may be held by a separately arranged holding member or a holding member integrally arranged with second casing 102. When first antenna element 108 is held by the holding member, the distance between first antenna element 108 and bottom surface 160 of second casing 102 can be maintained at a constant level, and therefore this further improves the performance of the antenna. On a plan view, second antenna element 109 is arranged at a position so that second antenna element 109 overlaps hinge section 103 in the vertical direction.

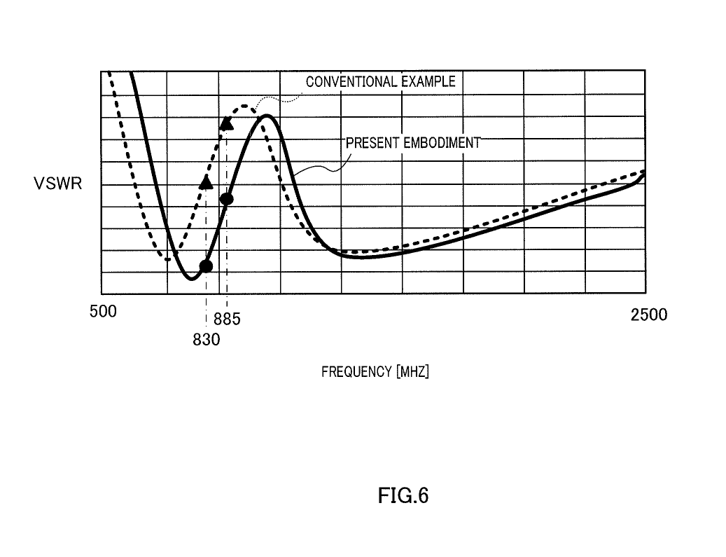

FIG. 6 is a figure illustrating VSWR characteristic when portable radio device 100 is placed on metal plate 210 such as steel desk. In FIG. 6, a solid line represents VSWR characteristic according to the present embodiment, and a broken line represents conventional VSWR characteristic. In FIG. 6, the lower the value of VSWR is in a vertical axis, the better the VSWR characteristic becomes.

As can be seen from FIG. 6, first antenna element 108 provides better VSWR characteristic in the resonance frequency of between 830 MHz to 885 MHz than a conventional example.

It should be noted that since hinge section 103 is made of a conductive metal material, not only metal plate 210 such as a steel desk but also hinge section 103 may reduce the antenna performance of first antenna element 108 and second antenna element 109. In particular, when feeding section 106 is in proximity to hinge section 103, hinge section 103 may function as an antenna by way of first antenna element 108 and second antenna element 109, whereby the antenna performance of first antenna element 108 or second antenna element 109 may be reduced. On the other hand, when second antenna element 109 oscillates in 2 GHz band, hinge section 103 has an electrical length at which hinge section 103 oscillates in 2 GHz band, like second antenna element 109. Therefore, in the present embodiment, base end section side 202 of first antenna element 108 and second antenna element 109, which overlap hinge section 103 on a plan view, are arranged in positions away from hinge section 103 in second casing 102 (see FIG. 2).

On the other hand, front end section side 201 of first antenna element 108 is more greatly affected by metal plate 210 than hinge section 103. Therefore, front end section side 201 of first antenna element 108 not overlapping hinge section 103 on a plan view is arranged in a distant position from metal plate 210 such as a steel desk in second casing 102. Therefore, each of the antenna elements is least affected by both hinge section 103 and metal plate 210 such as a steel desk.

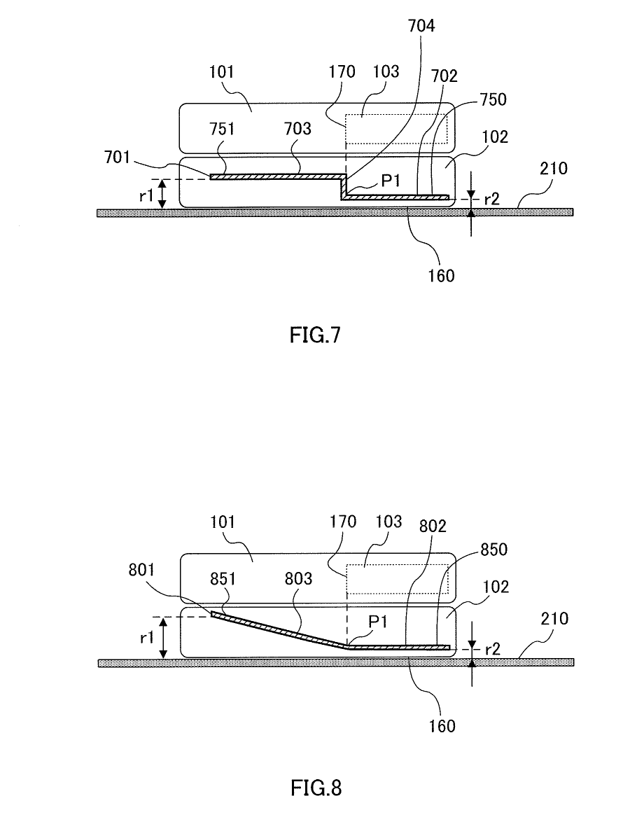

FIG. 7 is a front view of a portable radio device illustrating another example of a first antenna element. In FIG. 7, parts having the same configurations as those of FIGS. 1 to 5 will be assigned the same reference numerals, and their descriptions will be omitted.

As can be seen from FIG. 7, when seen from the front surface, first antenna element 701 is bent upward in a crank shape between base end section 750 and front end section 751, and is arranged in second casing 102 so that base end section side 702 and front end section side 703 are arranged parallel to bottom surface 160 of second casing 102. In other words, first antenna element 701 includes base end section side 702 arranged parallel to bottom surface 160 of second casing 102, front end section side 703 arranged parallel to bottom surface 160 of second casing 102 and whose distance from bottom surface 160 of second casing 102 is different from the distance of base end section side 202 therefrom, and bent section 704 provided between base end section 750 and front end section 751 and bending upward in a vertical direction.

More specifically, bent section 704 is formed by bending front end section 751 side upward in the vertical direction in position P1 to face edge section 170 of hinge section 103 between base end section 750 and front end section 751. Further, front end section side 703 is formed by bending in the vertical direction an end section of front end section 751 side of bent section 704 so that front end section side 703 is arranged parallel to bottom surface 160 of second casing 102.

Accordingly, first antenna element 701 is provided in second casing 102 so that distance r1 between front end section side 703 and bottom surface 160 of second casing 102 is greater than distance r2 between base end section side 702 and bottom surface 160 of second casing 102 (r1>r2). On a plan view (not shown), first antenna element 701 is arranged so that base end section side 702 overlaps hinge section 103 of second casing 102, like FIG. 1.

FIG. 8 is a front view of a portable radio device illustrating still another example of a first antenna element. In FIG. 8, parts having the same configurations as those of FIGS. 1 to 5 will be assigned the same reference numerals, and their descriptions will be omitted.

As can be seen from FIG. 8, when seen from the front surface, first antenna element 801 is arranged in second casing 102 such that first antenna element 801 is bent and brought upward so that the distance between first antenna element 801 and bottom surface 160 of second casing 102 gradually increases toward front end section 851. In other words, first antenna element 801 includes base end section side 802 arranged parallel to bottom surface 160 of second casing 102 and front end section side 803 provided between base end section 850 and front end section 851 and bending upward to the side of front end section 851.

More specifically, front end section side 803 is formed by bending front end section 851 side diagonally upward in position P1 to face edge section 170 of hinge section 103 between base end section 850 and front end section 851.

Accordingly, first antenna element 801 is provided in second casing 102 so that distance r1 between front end section side 803 and bottom surface 160 of second casing 102 is greater than distance r2 between base end section side 802 and bottom surface 160 of second casing 102 (r1>r2). On a plan view, first antenna element 801 is arranged so that base end section side 802 overlaps hinge section 103 of second casing 102.

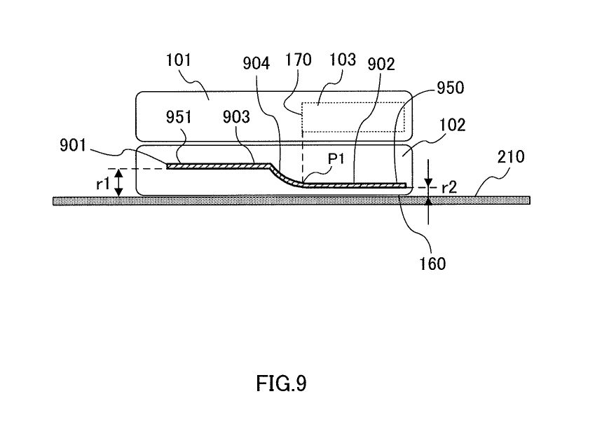

FIG. 9 is a front view of a portable radio device illustrating still another example of a first antenna element. In FIG. 9, parts having the same configurations as those of FIGS. 1 to 5 will be assigned the same reference numerals, and their descriptions will be omitted.

As can be seen from FIG. 9, when seen from the front surface, first antenna element 901 is arranged in second casing 102 such that first antenna element 901 is bent and brought upward between base end section 950 and front end section 951 so that the distance between first antenna element 901 and bottom surface 160 of second casing 102 gradually increases toward front end section 951, and front end section side 903 is bent so that front end section side 903 is parallel to bottom surface 160 of second casing 102. In other words, first antenna element 901 includes base end section side 902 arranged parallel to bottom surface 160 of second casing 102, front end section side 903 arranged parallel to bottom surface 160 of second casing 102 and whose distance from bottom surface 160 of second casing 102 is different from the distance of base end section side 902 therefrom, and curved section 904 provided between base end section 950 and front end section 951 and bending upward in a parabolic curve.

More specifically, curved section 904 is formed by bending front end section 951 side upward in a parabolic shape in position P1 to face edge section 170 of hinge section 103 between base end section 950 and front end section 951. Further, front end section side 903 is formed by bending an end section of front end section 951 side of curved section 904 so that front end section side 903 is arranged parallel to bottom surface 160 of second casing 102.

Accordingly, first antenna element 901 is provided in second casing 102 so that distance r1 between front end section side 903 and bottom surface 160 of second casing 102 is greater than distance r2 between base end section side 902 and bottom surface 160 of second casing 102 (r1>r2). On a plan view, first antenna element 901 is arranged so that base end section side 902 overlaps hinge section 103 of second casing 102.

As described above, according to the present invention, the base end section side of the first antenna element is arranged away from the hinge section, and the front end section side of the first antenna element is arranged away from the metal plate such as a steel desk, so that the portable radio device is small and thin but the manufacturing cost is still low, and while the quality of the design is not deteriorated, the reduction of the reception sensitivity is prevented even when the portable radio device is placed on a metal plate.

Further, according to the present embodiment, when the first antenna element is made in the shape as shown in FIG. 8, the maximum distance between the first antenna element and the bottom surface of the second casing can be increased, so that it is possible to reliably reduce the influence caused by the metal plate such as a steel desk.

### Embodiment 2

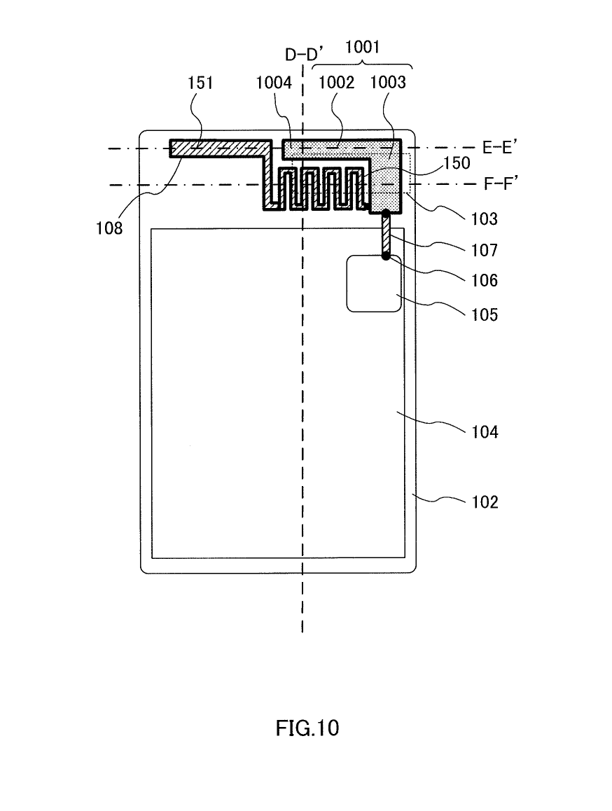

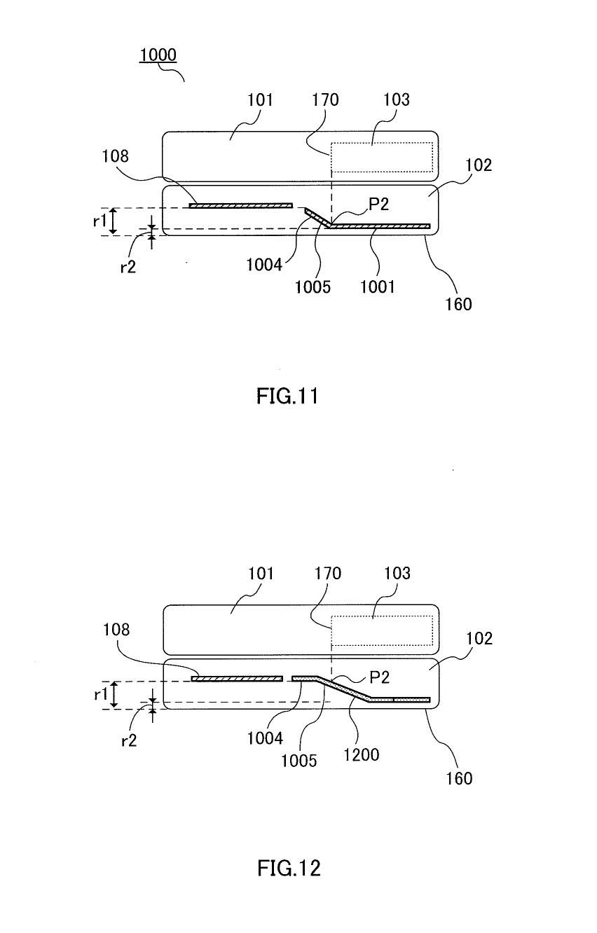

FIG. 10 is a plan view illustrating second casing 102 of portable radio device 1000 according to Embodiment 2 of the present invention. FIG. 11 is a cross sectional view taken along line E-E′ in FIG. 10. The cross sectional view taken along line D-D′ in FIG. 10 is the same as that of FIG. 5, the cross sectional view taken along line F-F′ in FIG. 10 is the same as that of FIG. 3. Accordingly, their descriptions will be omitted.

In second casing 102 of portable radio device 1000 as shown in FIG. 10, second antenna element 1001 is provided instead of second antenna element 109 in second casing 102 of portable radio device 100 according to Embodiment 1 as shown in FIG. 1. In FIG. 10, parts having the same configurations as those of FIG. 1 will be assigned the same reference numerals, and their descriptions will be omitted.

Portable radio device 1000 mainly includes first casing 101, second casing 102, hinge section 103, circuit substrate 104, matching circuit 105, feeding section 106, feeding element 107, first antenna element 108, circuit substrate 110, and second antenna element 1001.

Second antenna element 1001 is in a substantially inverted-L shape on a plan view, and, for example, second antenna element 1001 is made of a flexible substrate (FPC) or a metal plate, and is integrally formed with first antenna element 108. Further, second antenna element 1001 oscillates at a higher frequency than the resonance frequency of first antenna element 108, and therefore, second antenna element 1001 is formed so that the antenna length of second antenna element 1001 is shorter than that of first antenna element 108. Second antenna element 1001 includes long side section 1002 and short side section 1003 integrally formed with long side section 1002, and second antenna element 1001 feeds power to one end section of short side section 1003 from feeding section 106 via feeding element 107. Second antenna element 1001 is configured such that front end section 1004 of long side section 1002 is bent upward. One end section of short side section 1003 is integrally connected to base end section 150 of first antenna element 108.

More specifically, second antenna element 1001 is arranged such that short side section 1003 is arranged in second casing 102 such that short side section 1003 is parallel to bottom surface 160 of second casing 102 when seen from the front surface. Further, second antenna element 1001 is arranged such that one end section of long side section 1002 in a longitudinal direction is formed integrally with short side section 1003, and second antenna element 1001 is formed with inclined section 1005 that is inclined upward between one end section and the other end section in the longitudinal direction of second antenna element 1001. Inclined section 1005 is formed by bending front end section 1004 side upward in position P2 to face edge section 170 of hinge section 103 (see FIG. 11). Accordingly, second antenna element 1001 is provided in second casing 102 so that distance r1 between inclined section 1005 and bottom surface 160 of second casing 102 is greater than distance r2 between short side section 1003 and bottom surface 160 of second casing 102 (r1>r2). On a plan view, second antenna element 1001 is arranged in second casing 102 such that long side section 1002 overlaps hinge section 103, and short side section 1003 overlaps hinge section 103. Alternatively, in second antenna element 1001, the lower surface of inclined section 1005 bent upward may be held by a separately arranged holding member or a holding member integrally arranged with second casing 102. When second antenna element 1001 is held by the holding member, the distance between second antenna element 1001 and bottom surface 160 of second casing 102 can be maintained at a constant level, and therefore this further improves the performance of the antenna.

It should be noted that since hinge section 103 is made of a conductive metal material, not only metal plate 210 such as a steel desk but also hinge section 103 may reduce the antenna performance of second antenna element 1001. In particular, when feeding section 106 is in proximity to hinge section 103, hinge section 103 may function as an antenna by way of second antenna element 1001, whereby the antenna performance of second antenna element 1001 may be reduced. Therefore, in the present embodiment, a portion of long side section 1002 and short side section 1003 of second antenna element 1001 except inclined section 1005, which overlaps hinge section 103 on a plan view, is arranged at a position of second casing 102 that is away from hinge section 103. On the other hand, inclined section 1005 of long side section 1002 of second antenna element 1001, which does not overlap hinge section 103 on a plan view, is arranged at a position of second casing 102 that is away from the metal plate such as a steel desk. Therefore, each of the antenna elements is least affected by both hinge section 103 and the metal plate such as a steel desk.

As described above, the present embodiment has not only the advantages of above Embodiment 1 but also advantages stated below. Since the front end section side of the second antenna element is bent upward, the size and the thickness of the portable radio device can be reduced without increasing the manufacturing costs of not only the first antenna element but also the second antenna element, and while the quality of the design is not deteriorated, the reduction of the reception sensitivity is prevented even when the portable radio device is placed on a metal plate.

In the present embodiment, the first antenna element has the same shape as that of FIG. 2. However, the present embodiment is not limited to this. The first antenna element may be formed in any one of the shapes shown in FIGS. 7 to 9. In the present embodiment, the second antenna element is bent upward in position P2 to face the edge section of the hinge section. However, the present embodiment is not limited to this. As shown in FIG. 12, the second antenna element may be bent upward at any position. FIG. 12 is a cross sectional view taken along line E-E′ in FIG. 10 illustrating another example of a second antenna element according to the present embodiment. Second antenna element 1200 has the same structure as second antenna element 1001 as shown in FIGS. 10 and 11 except for the position at which second antenna element is bent upward. Second antenna element 1200 as shown in FIG. 12 is bent upward at a side of short side section 1003 (right side of FIG. 12) with respect to position P2 to face edge section 170 of hinge section 103 of long side section 1002. In other words, as shown in FIG. 12, second antenna element 1200 is bent upward at any position in accordance with how second antenna element 1200 is affected by hinge section 103 and metal plate 210. Therefore, second antenna element 1200 is less affected by both hinge section 103 and metal plate 210.

In above Embodiments 1 and 2, the first antenna element is made in the shapes shown in FIG. 2, 7, 8 or 9. However, the present invention is not limited to this. As long as the first antenna element is provided in second casing 102 so that distance r1 between the front end section side and the bottom surface of second casing 102 is greater than distance r2 between the base end section side and bottom surface 160 of second casing 102, the first antenna element can be formed in any shape. In above Embodiments 1 and 2, only two antenna elements are provided. More specifically, the first antenna element and the second antenna element are provided. However, the present invention is not limited to this. Only the first antenna element may be provided, or three or more antenna elements may be provided. In above Embodiments 1 and 2, the first casing and the second casing are rotatably coupled via the hinge section. However, the present invention is not limited to this. The present invention may also be applied to a case where a metal rail is provided to slidably couple the first casing with the second casing. In this case, the meaning of “movable” includes both rotation operation and slide operation. In above Embodiments 1 and 2, the first antenna element is bent upward at the position to face the edge section of the hinge section. However, the present invention is not limited to this. The first antenna element may be bent upward at any position. In above Embodiments 1 and 2, the hinge section is provided in the first casing. However, the present invention is not limited to this. The hinge section may be provided in the second casing.

The disclosure of Japanese Patent Application No. 2008-317387, filed on Dec. 12, 2008, including the specification, drawings, and abstract, is incorporated herein by reference in its entirety.

### INDUSTRIAL APPLICABILITY

The portable radio device according to the present invention is particularly suitable for maintaining high reception sensitivity while the portable radio device is placed on a metal plate such as a steel desk.

1. A portable radio device comprising:
a first casing;
a second casing;
a conductive coupling member that couples the first casing and the second casing in a mutually movable fashion; and
a first antenna element that is fed by a feeding section and has a base end section arranged at a position to face the coupling member in a vertical direction, wherein the first antenna element is arranged in the second casing such that a distance between a front end section side extending from the base end section and a bottom surface of the second casing is greater than a distance from the bottom surface of the base end section side.

2. The portable radio device according to claim 1 further comprising a second antenna element that resonates at a higher frequency than a resonance frequency of the first antenna element and electrically connects to the first antenna element.

3. The portable radio device according to claim 1, wherein the first antenna element is arranged in the second casing such that the first antenna element is bent and brought upward so that a distance between the first antenna element and the bottom surface gradually increases toward the front end section.

4. The portable radio device according to claim 1, wherein the first antenna element is bent upward in a crank shape between the base end section and the front end section, and is arranged in the second casing such that the base end section side and the front end section side are arranged parallel to the bottom surface.

5. The portable radio device according to claim 1, wherein the first antenna element is arranged in the second casing such that the first antenna element is bent and brought upward between the base end section and the front end section so that a distance between the first antenna element and the bottom surface gradually increases toward the front end section, and the front end section side is bent so that the front end section side is parallel to bottom surface.

6. The portable radio device according to claim 1, wherein the front end section side of the first antenna element is bent upward at a position to face the edge section of the coupling member between the base end section and the front end section.
